(19) United States
(12) Patent Application Publication
(10) Pub. No.: US 2025/0277805 A1
(43) Pub. Date: Sep. 4, 2025

(54) SELECTING A POSITION FOR MULTIPLE PROCESS FLUIDS IN AN ANALYSIS DEVICE

(71) Applicant: Agilent Technologies, Inc., Santa Clara, CA (US)

(72) Inventors: Dominik Ruf, Baden Weurttemberg (DE); Niklas Kirchenbauer, Waldbronn (DE)

(21) Appl. No.: 19/067,340

(22) Filed: Feb. 28, 2025

(30) Foreign Application Priority Data
Mar. 1, 2024 (DE) 102024105923.0

(51) Int. Cl. G01N 35/10; G01N 30/02; G01N 30/24; G01N 30/88; G01N 35/00; G01N 35/04

(52) U.S. Cl. CPC G01N 35/10; G01N 30/24; G01N 35/0092; G01N 35/0099; G01N 35/04; G01N 2030/027; G01N 2030/8804; G01N 2035/0441

(57) ABSTRACT

An analysis device for carrying out an analysis method includes multiple defined positions at which process fluids can be received. A defined position is selected. The selected position is mechanically provided to a user and/or a sample handling device. The selection is based on the content of the process fluids and/or a user behavior with respect to the process fluids. The analysis device may be configured for performing sample separation, such as by chromatography or electrophoresis.

### CROSS-REFERENCE TO RELATED APPLICATIONS

The present application claims the benefit of German Patent Application No. DE 10 2024 105 923.0, filed on Mar. 1, 2024, which is incorporated herein by reference in its entirety.

### TECHNICAL FIELD

The present disclosure relates to a method for operating an analysis device for carrying out an analysis method, wherein the analysis device comprises multiple defined positions and one or more process fluids can be received in each position. The method comprises: selecting a particular one of the positions and mechanically providing the selected position to a user and/or a process fluid handling device, wherein selecting the particular position is based on the content of the process fluids contained in the positions and/or a user behavior with respect to the process fluids contained in the positions. Additionally or alternatively, the method can comprise: automatically selecting a particular one of the positions, which is associated with a particular plurality of process fluids, as a starting position. The present disclosure further relates to an apparatus for data processing, which is configured to carry out the method, and to the analysis device.

### BACKGROUND

Analysis devices are, for example, chromatography devices, in particular sample separation devices, for analyzing a sample, in particular a fluidic sample, e.g. for performing a chromatographic separation of the sample.

In an HPLC (high-performance liquid chromatography) chromatography device, for example, a liquid (mobile phase) is moved at a very precisely controlled flow rate (for example in the range of microliters to milliliters per minute) and at a high pressure (typically 20 to 1000 bar and above, currently up to 2000 bar), at which the compressibility of the liquid can be noticeable, through a so-called stationary phase (for example in a chromatographic column), in order to separate individual fractions of a sample liquid introduced into the mobile phase from one another. After passing through the stationary phase, the separated fractions of the fluidic sample are detected in a detector. Such an HPLC system is known, for example, from EP 0,309,596 B1 of the same applicant, Agilent Technologies, Inc.

Existing analysis devices usually use a high number of samples, which have to be organized, in particular if an automatic measurement of the samples is desired. In order to organize a plurality of samples, sample holders can therefore be used, which can hold a plurality of (fluidic) samples, e.g. in the ten or hundred range. In this case, the samples can be introduced or pipetted directly into the sample holder (e.g. well plate) or initially filled into sample containers (e.g. vials), wherein the sample containers are then arranged e.g. in the sample holder.

Multiple positions can be provided in a sample chamber (sampler) of an analysis device in order to respectively position a plurality of samples, sample containers, or sample holders there. The positions can now be mechanically movable in the sample chamber, e.g. arranged on a turntable. In this way, a particular plurality of samples can be rotated to a particular position. For example, a particular position should be located directly at an entry region of the sample chamber. This is done e.g. in order to remove samples and position new samples. For example, only that position which is arranged directly at the entry region of the sample chamber can be directly accessible.

Conventionally, selecting the position and mechanically providing this position (e.g. by turning the sample plate) is carried out manually by a user. After the user has taken a close look at which sample is in which position, the user can then press a button on the device until the desired sample holder has been rotated to the correct position, for example. For this purpose, however, the user must already know which position is the “correct” position. However, this procedure requires some effort and some prior knowledge of the user and is also not suitable for remote operation.

### SUMMARY

There may be a need to operate an analysis device (in particular the handling of a process fluid) efficiently and in a user-friendly manner.

In the following, two methods, an apparatus for data processing, and an analysis device are described.

According to a first aspect of the present disclosure, a method for operating an analysis device (e.g. an HPLC device or system) for carrying out an analysis method is described, wherein the analysis device comprises multiple defined positions (e.g. positions for sample holders on a rotary table) and at least one process fluid, in particular a plurality of process fluids, can be received in each position (e.g. samples, references, standards, etc.), the method comprising:
i) selecting a particular one of the positions and ii) mechanically providing (e.g. by means of rotating the rotary table) the selected position to a user and/or a sample handling device.

Selecting the particular position is based on the content of the process fluids contained in the positions and/or a user behavior with respect to the process fluids contained in the positions.

According to a second aspect of the present disclosure, a method for operating an analysis device for carrying out an analysis method is described, wherein the analysis device comprises multiple defined positions (e.g. positions for sample holders on a rotary table) and at least one process fluid, in particular a plurality of process fluids, can be received in each position (e.g. samples, references, standards, etc.), the method comprising:

selecting (automatically) a particular one of the positions, which is associated with a particular process fluid, in particular a particular plurality/multiplicity of process fluids, as a starting position. In this case, the analysis device may be configured as a high-performance liquid chromatography (HPLC) device.

According to a third aspect of the present disclosure, an apparatus for data processing is described, which comprises at least one processor and which is configured to carry out the method described above.

According to a fourth aspect of the present disclosure, an analysis device for carrying out an analysis method is described, wherein the analysis device comprises: an apparatus for data processing as described above, and the multiple defined positions (in a sample chamber).

In the context of the present disclosure, the term “analysis device” may denote in particular a device which is able and configured to examine, in particular to separate, a fluidic sample, further in particular to separate it into different fractions. For example, such a sample separation can be carried out by means of chromatography or electrophoresis. The analysis device may be a liquid chromatography sample separation device. The analysis device is configured in particular to carry out an analysis method or a (possibly planned or programmed) sequence of analysis methods or procedures. Furthermore, the term “analysis method” can also be used as a representative for a sequence, a sequence, a program, an execution list of the analysis methods, procedures or rules, including adaptation, preparation, equilibration (intermediate) steps and the like.

In the context of the present disclosure, the term “fluidic sample” denotes in particular a medium, further in particular a liquid, which contains the matter actually to be analyzed (for example a biological sample), such as for example a protein solution, a pharmaceutical sample, etc.

In the context of the present disclosure, the term “mobile phase” denotes in particular a fluid, further in particular a liquid, which serves as a carrier medium for transporting the fluidic sample between a fluid drive and a sample separation device. However, the mobile phase can also be used in a fluid conveying device for influencing the fluidic sample. For example, the mobile phase can be a (for example organic and/or inorganic) solvent or a solvent composition (for example water and ethanol).

In the context of the present disclosure, the term “process fluid” may denote in particular a fluid which is associated with an analysis device or is associated with the processes in an analysis device (that is to say e.g. a fluid which undergoes a separation process in a chromatographic column in an HPLC system). In an example, a process fluid can be a fluidic sample which is to be analyzed by the analysis device. In a further example, a process fluid can also be a reference fluid or a standard fluid. A solvent can also be a process fluid, e.g. if a control measurement (without sample) is carried out.

In the context of the present disclosure, the term “position” may denote in particular a locality which is suitable for positioning (e.g. arranging, introducing, depositing) one or more (a plurality) process fluid(s). In an example, a plurality of process fluids (e.g. in respective process fluid containers) can be arranged at a position. In a further example, the process fluids (with or without respective process fluid containers) can be stored in a process fluid holder. This process fluid holder can then be arranged at the position. In an example, at least one process fluid holder can be positioned at each position. Each position may be defined or uniquely identifiable, e.g. position-1, position-2, etc. In an exemplary embodiment, in addition, each position, or the process fluids associated with this position, is/are “mechanically movable” at least in one spatial direction. As a result, it can be made possible for each position to be provided as a selected position or a start position. Such a movement can be realized e.g. by a rotary movement of a turntable. In a further example, a process fluid can be arranged in a container at a position.

In the context of the present disclosure, the term “process fluid handling device” may denote in particular an apparatus which is suitable for receiving, transporting, and releasing a process fluid again. The process fluid handling device may have a needle and a process fluid receiving volume. Furthermore, a process fluid handling device can have an extension arm, by means of which the needle or the process receiving volume can be moved in the process fluid space. In one example, the process fluid handling device can control the multiple defined positions and then remove process fluid at a specific location in a targeted manner.

In the context of the present disclosure, the term “content of the process fluids contained in the positions” may denote in particular the circumstance that selecting the position is based on the contents or process fluids of the respective positions. In an example, it is determined that a process fluid has already expired or has already been measured. Based on this, the corresponding position can be moved mechanically into the vicinity of the entry region of the process fluid space in order to remove these process fluids as quickly as possible. In a further example, it is determined that a process fluid is urgently to be measured (e.g. because of time specifications or imminent degradation). Based on this, the corresponding position can be moved into the vicinity of the process fluid handling device in order to enable the process fluid to be received in a timely manner.

In the context of the present disclosure, the term “user behavior” may denote in particular that the behavior of one or more users is taken as a basis for selecting the position. The user behavior may relate to past events. However, it is also possible, for example, to infer from the past behavior of the user his/her future actions. In an example, a user regularly measures particular samples at particular positions. Accordingly, these positions can be provided directly when the user starts the analysis device. The user behavior may be understood as a model which is created (automatically) based on actions of the user. An AI (artificial intelligence) module may be especially efficient for creating and further developing this model.

In the context of the present disclosure, the term “starting position” may denote in particular a position for which the next action is to be carried out. Such an action may be receiving process fluid and performing an analysis. Furthermore, such an action may also comprise removing or replacing a process fluid (or a process fluid holder). In an example, a starting position may be a particular position with respect to the user, for example in order to remove or add process fluid in a subsequent step. An automatic provision of a starting position (in particular based on the position which is associated with a particular plurality of process fluids (and the content thereof)) is hitherto not known from the field of HPLC.

According to an exemplary embodiment, the present disclosure may be based on the idea that an analysis device (in particular the handling of a process fluid) can be operated efficiently and in a user-friendly manner if the provision of a position comprising a plurality of process fluids is carried out based on the content of the process fluids contained in the positions and/or a user behavior (with respect to the process fluids contained in the positions). Additionally or alternatively, a starting position can be selected and provided directly and automatically in an HPLC device.

Aspects of the present disclosure can reduce the required human interaction with a system of the analysis device and can thereby improve the efficiency and the user experience. In addition to the user experience, aspects of the present disclosure can also improve the automation of the positioning, whereby time and effort in the input of process fluids, such as samples, are reduced.

The automatic positioning system can be designed e.g. such that it brings the process fluid positions (e.g. on a rotary table) into the correct/desired position in the chamber based on predefined rules and/or external commands. This can enable efficient sample access and efficient processing.

### EXEMPLARY EMBODIMENTS

Additional embodiments are described below.

According to an exemplary embodiment, the user behavior is based on at least one of the following: past events (with respect to the process fluids contained in the positions), current expectations (with respect to the process fluids contained in the positions), and future expectations (with respect to the process fluids contained in the positions). The user experience can be significantly improved if the selection of the position is guided by the behavior of a (particular) user. For example, the behavior of one or more users can be monitored over time, so that habits and preferences can be included. For example, a particular user can always position samples to be urgently measured at position-1 and samples to be measured less importantly always at position-3. Furthermore, the user may arrange sample holders with reference fluids (e.g. for calibration purposes) at position-2, for example. Based on such observations, an (individual) user behavior can be estimated.

A user behavior from the past can be used to estimate or extrapolate a current or future user behavior. For example, it can be estimated what a particular user will measure next and which position may be the preferred position for this. Furthermore, current or future events can also be derived from a sample catalog or measurement plan. In an example, in addition, external systems can provide data which provide a particular measurement history or commission measurements. This data with respect to future measurements can be combined with the known user behavior in order to identify and provide the preferred position. In an example, the system can recognize that a calibration by means of a reference fluid is necessary and then select a corresponding position, which comprises such a fluid, as a starting position.

According to an exemplary embodiment, mechanically providing the selected position comprises at least one of the following: a turning, a pushing, a pivoting, a conveying, a driving, and a use of a robot arm. This can have the advantage that mechanically providing can be implemented directly by means of mechanisms which are already present in the analysis device, whereby costs and effort can be saved. In an exemplary example, the positions can be arranged on a rotary table and rotated therewith. In an example, a kind of “paternoster” is provided, in which providing the position can also be achieved via a turning and/or pivoting. In an example, an elevator with the positions is used, wherein the movement comprises a driving or displacement (linear movement in the Z direction). In a further example, the positions can be arranged on a conveyor belt, whereby a driving/conveying is also implemented. In another example, the mechanical movement can also be carried out by a mechanical arm (robot arm), e.g. by a gripper known from the field of analysis devices (in particular a vial gripper).

According to an exemplary embodiment, the method further comprises: positioning a process fluid holder, which comprises process fluid locations for a plurality of process fluids, at at least one of the multiple positions. This may have the advantage that the plurality of process fluids can be organized in a defined and stable manner at a particular position. In addition, corresponding process fluid holders can be exchanged efficiently, wherein the plurality of process fluids associated with one another always remain adjacent to one another.

According to an exemplary embodiment, the process fluid holder comprises at least one of the following: a tray, a well plate, a sample bottle holder, a microtiter plate, a process fluid rack, and a vial rack. In this way, established and frequently used objects can be used directly.

According to an exemplary embodiment, the process fluid is provided separately or in a process fluid container. In a first example, a plurality of process fluids without sample containers (sample bottle, vial) can be arranged in a position, e.g. in the openings of a well plate. In a second example, the process fluids can be respectively stored in process fluid containers. The process fluid containers can be arranged directly in a position or held in a process fluid holder (e.g. vial rack) which is then arranged in the position.

According to an exemplary embodiment, the selecting comprises: selecting a free position from the multiple defined positions (position free). If it is assumed, for example, that new process fluids or process fluid holders are to be provided, a free position can be determined as a selected position or starting position.

According to an exemplary embodiment, selecting comprises: selecting a position from the multiple defined positions at which a process fluid holder with free process fluid locations is positioned (e.g. sample holder with free locations). If, on the other hand, individual process fluids are provided, that process fluid holder can be preferred which has sufficiently free locations or is thematically suitable. The corresponding position can then be provided mechanically.

According to an exemplary embodiment, selecting the particular position is based on that at least one process fluid, in particular from a particular process fluid holder, shall be removed. The removal can have different reasons, for example already measured or already degraded. A removal can be especially efficient when the corresponding position is provided to the user.

According to an exemplary embodiment, the at least one process fluid is to be removed because it has already been measured (processed). According to an exemplary embodiment, the particular process fluid holder is to be removed because the process fluids to be measured have already been measured.

According to an exemplary embodiment, the at least one process fluid is to be removed because it has expired and/or is degraded. According to an exemplary embodiment, the particular process fluid holder is to be removed because at least one process fluid has expired and/or is degraded. According to an exemplary embodiment, the at least one process fluid is to be removed because it is no longer trustworthy. According to an exemplary embodiment, the particular process fluid holder is to be removed because at least one process fluid is no longer trustworthy, in particular due to insufficient tempering. In one example, the trustworthiness can be lost due to external circumstances such as e.g. sampler has not cooled, condensate on lid, etc.

According to an exemplary embodiment, selecting the particular position is based on one or more process fluids to be measured having the highest priority or the lowest priority. In this case, the term “priority” may relate to performing an analysis/measurement. This can result in the advantage that process fluids or process fluid holders can be organized according to their priority, whereby the efficiency can be increased.

According to an exemplary embodiment, selecting the particular position is based on a reference (standard) being introduced or removed, in particular because the reference standard has expired and/or is degraded. Like a sample, a reference fluid also may have expired or become degraded, or simply may have been already measured. Corresponding selection rules can thus be transferred.

According to an exemplary embodiment, selecting the particular position is based on which positions and/or which process fluid holder has been used in the past, in particular under certain conditions (clearly: which position has been used in the past? Is there a pattern? For example, positions 3-1-2-3-1-2).

According to an exemplary embodiment, selecting the particular position is based on the circumstance that a particular process fluid has been introduced into a control system of the analysis device but has not yet been measured. Future measurement orders can be derived therefrom. For example, in the CDS/LIMS (Laboratory Information Management System) (data management system for the laboratory environment, in particular for the logging in and out of samples, the planning of analyses, the allocation of resources, the storage or provision of measurement results (via the network), reporting etc.), a sample may be set up for measurement, which has not been set into the sampler.

According to an exemplary embodiment, selecting the particular position is based on an external control system providing a specification, in particular by means of meta data. For example, the analysis device or its control system can be notified of the next position from an external source/software (e.g. via corresponding interfaces). In an example, process fluids can be automatically identified (e.g. via bar code), so that the system automatically obtains an overview of the samples to be measured. This information can be used to select the suitable (start) position.

According to an exemplary embodiment, the selected position and/or the start position is arranged closer to an entry/opening region of a process fluid space than the further defined positions. According to an exemplary embodiment, the opening region or loading/removal opening (e.g. a door) can be configured for introducing and/or discharging process fluid and/or process fluid holders with respect to the process fluid space.

According to an exemplary embodiment, selecting the particular position comprises at least one of the following features: an expectation position and/or an experience position, an expectation margin for a particular position, performing a particular measurement, modeling, simulating, using an artificial intelligence, AI, algorithm. As a result, the selection (in particular based on user behavior and/or content) can be further improved. The more experience that is included in the selection, the better the user experience can be.

According to an exemplary embodiment, the analysis device further comprises: a process fluid space, wherein the process fluid space comprises at least one of the following: a process fluid plate, a process fluid elevator, a process fluid drawer, a conveyor belt. This may have the advantage that established mechanisms can be used directly, which are already present in the analysis device without additional effort.

In an example, aspects of the described disclosure may be performed by software on an existing analysis device. In a further example, the hardware of the analysis device may be adapted specifically for the described disclosure.

Embodiments of the present disclosure may be partly or entirely embodied or supported by one or more suitable software programs or products, which can be stored on or otherwise provided by any kind of non-transitory medium or data carrier, and which might be executed in or by any suitable data processing unit such as an electronic processor-based computing device (or system controller, controller, control unit, device or apparatus for data processing, etc.) that includes one or more electronic processors and memories. Software programs or routines (e.g., computer-executable or machine-executable instructions or code) may be applied in or by the control unit, e.g. a data processing system such as a computer, such as for executing any of the methods described herein.

According to an exemplary embodiment, the analysis device (or system) is configured as a sample separation device (or system). According to an exemplary embodiment, the analysis device comprises a fluid drive for driving a mobile phase and a fluidic sample injected into the mobile phase. According to an exemplary embodiment, the analysis device comprises a sample separation device for separating the fluidic sample injected into the mobile phase. According to an exemplary embodiment, the analysis device is configured for analyzing at least one physical, chemical and/or biological parameter of the fluidic sample. According to an exemplary embodiment, the analysis device is configured as a sample separation device for separating the fluidic sample.

In the context of the present application, the term “sample separation device” or “sample separation unit” may denote in particular a device for analyzing a fluidic sample, in particular into different fractions. For this purpose, constituents of the fluidic sample may first be adsorbed on the sample separation device and then desorbed separately (in particular in fractions). For example, such a sample separation device may be configured as a chromatographic separation column.

According to an exemplary embodiment, the analysis device is a chromatography device, in particular a liquid chromatography device, a gas chromatography device, an SFC (supercritical liquid chromatography) device, an HPLC (high-performance liquid chromatography) device, or a 2D-LC (two-dimensional liquid chromatography) device.

According to an exemplary embodiment, the analysis device is configured as a microfluidic device. According to an exemplary embodiment, the analysis device is configured as a nanofluidic device.

According to an exemplary embodiment, the sample separation device or unit is configured as a chromatographic separation device, in particular as a chromatographic separation column.

According to an exemplary embodiment, the fluid drive is configured for driving the mobile phase and the fluidic sample under high pressure.

According to an exemplary embodiment, the fluid drive is configured for driving the mobile phase and the fluidic sample at a pressure of at least 500 bar, in particular of at least 1000 bar, further in particular of at least 1200 bar, further in particular of at least 1500 bar.

According to an exemplary embodiment, the analysis device comprises a detector for detecting the analyzed, in particular separated, fluidic sample.

According to an exemplary embodiment, the analysis device comprises a fractionator for fractionating separated fractions of the fluidic sample.

The analysis device can be a microfluidic measuring device, a life science device, a liquid chromatography device, a gas chromatography device, an HPLC (high-performance liquid chromatography) device, a UHPLC (ultra-high-performance liquid chromatography) device, a 2D-LC (two-dimensional liquid chromatography) device, or an SFC (supercritical liquid chromatography) device. However, many other applications are possible.

According to an exemplary embodiment, the sample separation device or unit can be configured as a chromatographic separation device, in particular as a chromatographic separation column. In a chromatographic separation, the chromatographic separation column can be provided with an adsorption medium. The fluidic sample can be held thereon and only subsequently may be detached again in fractions in the presence of a specific solvent composition, whereby the separation of the sample into its fractions is accomplished.

A pumping system for conveying fluid can be configured, for example, to convey the fluid or the mobile phase through the system at a high pressure, for example a few 100 bar up to 1000 bar and more. The analysis device can comprise a sample injector for introducing the sample into the fluidic separation path. Such a sample injector can comprise a sample or injection needle which can be coupled to a needle seat in a corresponding liquid path, wherein the sample needle can be moved out of this needle seat in order to receive sample. After the reintroduction of the sample needle into the needle seat, the sample can be located in a fluid path which can be switched into the separation path of the system, for example by the switching of a valve. In another exemplary embodiment of the present disclosure, a sample injector or sampler with a sample needle which is operated without a needle seat can be used.

The analysis device can comprise a fraction collector for collecting the separated components. Such a fraction collector can guide the different components of the separated sample into different liquid containers, for example. However, the analyzed sample can also be fed to a drain container or waste.

The analysis device may comprise a detector for detecting the separated components. Such a detector can generate a signal which can be observed and/or recorded and which is indicative of the presence and quantity of the sample components in the fluid flowing through the system.

According to an exemplary embodiment, a process fluid space (sampling space) is delimited by means of a housing in which the process fluid handling device is arranged.

In an exemplary embodiment, the disclosure includes an automatic positioning system within an HPLC system which changes into the correct position when the door is opened or after each sample removal. The correct position can be determined e.g. according to the following rules or a combination thereof: the most frequently used position, a position which has been processed by the HPLC (all samples measured), and a position with free capacities, set externally (e.g. by a LIMS system) per API call.

In an exemplary embodiment, e.g. also preparatory systems can benefit from the described method. Thus, for example, virtually all fraction collectors have an apparatus with which containers can be suitably positioned, either for receiving the eluate/fraction or for removing a container.

### BRIEF DESCRIPTION OF THE DRAWINGS

Other aims and many of the attendant advantages of embodiments of the present disclosure will become readily apparent and will become better understood by reference to the following more detailed description of embodiments in conjunction with the accompanying drawings. Features that are substantially or functionally the same or similar are provided with the same reference signs.

FIG. 1 shows an analysis device configured as a chromatography device, according to an exemplary embodiment of the present disclosure.

FIG. 2 shows a side view of multiple defined positions on a process fluid plate, according to an exemplary embodiment of the present disclosure.

FIG. 3 shows a top view of multiple defined positions on a process fluid plate, according to an exemplary embodiment of the present disclosure.

FIG. 4 shows a process fluid space with a process fluid handling device and the defined positions, according to an exemplary embodiment of the present disclosure.

The illustrations in the drawings are schematic.

### DETAILED DESCRIPTION

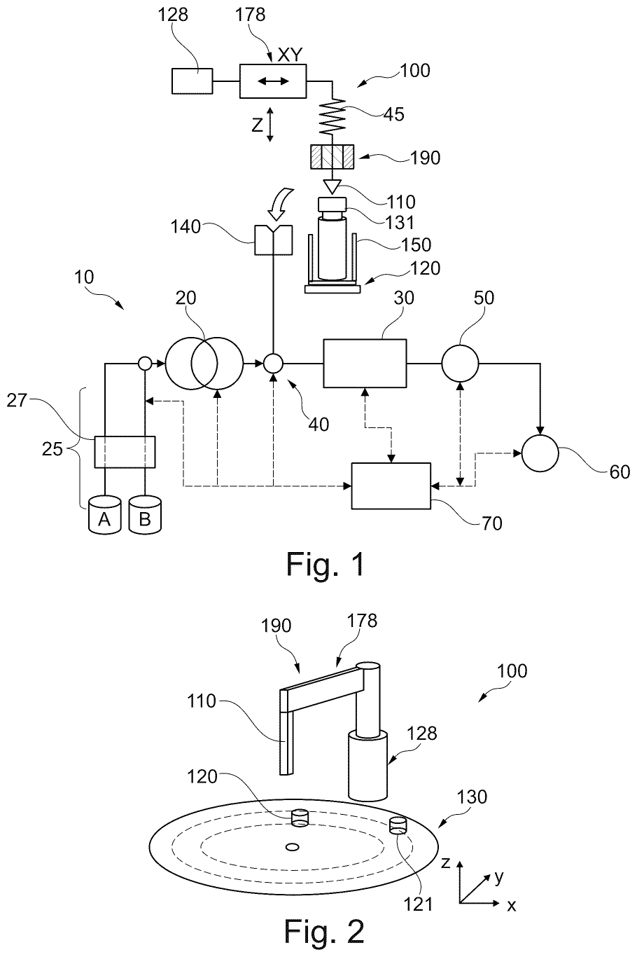

FIG. 1 shows the basic structure of an HPLC system as an example of an analysis device or system 10 configured as a sample separation device or chromatography device, according to an exemplary embodiment of the present disclosure, as can be used, for example, for liquid chromatography. A fluid conveying device or a fluid drive 20, which is supplied with solvents from a supply device 25 (or consumable material from a container), drives a mobile phase through a sample separation device or unit 30 (such as, for example, a chromatographic column), which contains a stationary phase.

The solvents are consumable materials that are stored in one or more containers. The supply device 25 usually comprises a first fluid component source (e.g. first container) for providing a first fluid or a first solvent component A (for example water) and a second fluid component source (e.g. second container) for providing another second fluid or a second solvent component B (for example an organic solvent).

An optional degasser 27 can degas the solvents provided by means of the first fluid component source and by means of the second fluid component source before they are fed to the fluid drive 20. A sample feed unit, which can also be referred to as an injector 40, is arranged between the fluid drive 20 and the sample separation device 30 in order to initially receive a sample liquid or a fluidic sample from a sample container 131 into a sample receiving volume 45 in an injector path, and subsequently introduce it into a fluidic separation path between fluid drive 20 and sample separation device 30 by switching an injection valve of the injector 40. The fluidic sample can be received from the sample container 131 in particular by a sample needle 110 being moved out of a sample seat 140 and moved into the sample container 131, fluidic sample being sucked out of the sample container 131 through the sample needle 110 into the sample receiving volume 45 by means of a fluid conveying device configured as a dosing (or metering) unit, and the sample needle 110 then being moved back into the needle seat 140.

The stationary phase of the sample separation device 30 is provided for separating components of the sample. A detector 50, which can comprise a flow cell, detects separated components of the sample. A fractionizing device (or unit) or fractionator 60 can be provided for outputting separated components of the sample into containers provided therefor. Liquids which are no longer required can be output into a drain container or into a waste line.

While a liquid path between the fluid drive 20 and the sample separation device 30 is typically under high pressure, the sample liquid is initially introduced under normal pressure into a region separated from the liquid path, namely the sample loop or the sample receiving volume 45, of the sample feed unit or of the injector 40. Thereafter, the sample liquid is introduced into the separation path under high pressure. A sample loop as the sample receiving volume 45 may denote a portion of a fluid line which is configured for receiving or temporarily storing a predefined quantity of fluidic sample. Even before the sample liquid initially under normal pressure in the sample receiving volume 45 is switched into the separation path under high pressure, the content of the sample receiving volume 45 may be brought to the system pressure of the analysis device 10 configured as an HPLC system by means of a dosing (or metering) unit in the form of the fluid conveying device. A control unit or a control system 70 controls the individual components 20, 25, 30, 35, 50, 60, etc., of the analysis device 10.

The sample is transported from a sample needle 110 to a needle seat 140 and then injected into the analytical domain. The sample and/or the process fluid is transported by means of a process fluid handling device 190. This has an extension arm or robot arm 178, which can be moved in the three spatial directions by means of a drive 128. The process fluid handling device 190 is arranged in a process fluid space (sampler) 100 in which a plurality of defined positions 120 are also located. Each position 120 is configured for positioning a plurality of process fluids, in particular samples. In FIG. 1, a sample container 131 is schematically illustrated at a first position 120. Furthermore, it is schematically illustrated that the sample container 131 (actually a plurality of sample containers 131) is arranged in a process fluid holder 150. The process fluid handling device 190 now controls the sample container 131 and sucks up a part of the sample contained in the sample container 131 by means of the needle 110. Thereafter, the sample can be transported to the mentioned needle seat 140 and injected there.

FIG. 2 shows a side view of multiple defined positions 120, 121 on a process fluid plate 130, according to an exemplary embodiment of the present disclosure. A process fluid handling device 190 (as described above) is arranged in a process fluid space 100 and configured to control a first defined position 120 or a second defined position 121. Both positions 120, 121 are schematically illustrated and arranged on the process fluid plate 130, which in the present example is rotatable or turnable (in the horizontal plane). Accordingly, the process fluid plate 130 can be rotated (moved mechanically) such that a specific one of the positions 120, 121 is provided to the process fluid handling device 190.

Selecting the particular position 120, 121 can be based on the content of the process fluids contained in the positions and/or a user behavior with respect to the process fluids contained in the positions. Furthermore, a specific one of the positions (based on the content of the contained process fluids) can be automatically selected as a starting position for control by the process fluid handling device 190.

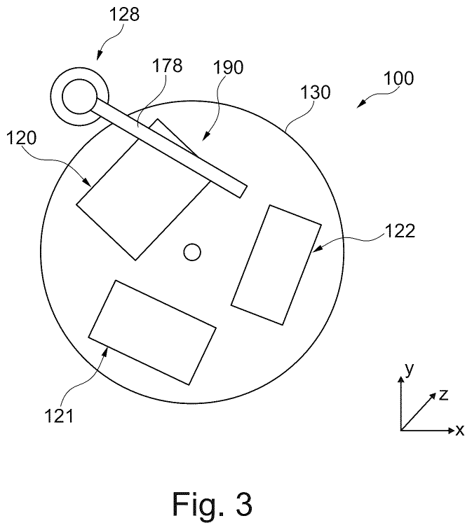

FIG. 3 shows a top view of multiple defined positions 120, 121, 122 on a process fluid plate 130, according to an exemplary embodiment of the present disclosure. A process fluid space 100 similar to that of FIG. 2 is shown from above, wherein in FIG. 3, however, three defined positions 120, 121, 122 are present, wherein each is configured for positioning a plurality of process fluids. In particular, the process fluids are positioned/placed separately (e.g. in a well plate) or in a sample container 131 (e.g. vial) and/or a process fluid holder 150 (e.g. a plurality of vials in a rack) on the positions 120, 121, 122. The process fluid plate 130 can be rotated such that a specific position of the process fluid handling device 190 is provided. This can also be the selection of a starting position. In an example, both the process fluid handling device 190 and the process fluid plate 130 are rotatable, in particular relative to each other.

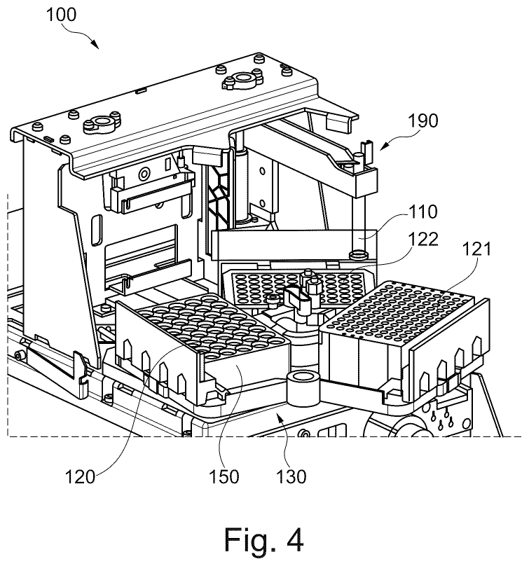

FIG. 4 shows a process fluid space 100 with a process fluid handling device 190 and the defined positions 120, 121, 122, according to an exemplary embodiment of the present disclosure. In this illustrative example, a process fluid holder 150 is now positioned at each defined position 120, 121, 122 on the process fluid plate 130. In the shown example, the process fluid holder 150 is a rack in which a plurality of process fluid containers 131 (vials) can be arranged or, alternatively, the process fluid holder 150 is a multi-well plate (e.g., a microtiter plate) in which process fluids are contained in one or more individual wells of the multi-well plate. The position on the right side 121 can be considered here as a start position (and/or selected position) which is assigned to an entry/opening region of the process fluid space 100. This position 121 can be very easily accessible for a user. However, the user does not have to make an effort himself or herself to identify the selected position/start position and move it into the accessible region. Instead, this is automatically determined and the process fluids associated with this position are automatically provided to the user.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the control device or control system 70 (or electronic processor-based computing device, system controller, controller, control unit, data processing unit, device for data processing, etc.) schematically depicted in FIG. 1. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), or field-programmable gate arrays (FPGAs). Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the control device or control system 70 schematically depicted in FIG. 1), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It should be noted that the term “comprise” does not exclude other elements and that the term “a” does not exclude a plurality. Also, elements which are described in conjunction with different embodiments can be combined. It should also be noted that reference signs in the claims should not be interpreted as limiting the scope of the claims.

### REFERENCE SIGNS

10 Analysis Device
20 Fluid Drive
25 Solvent
27 Degasser
30 Sample Separation Device
40 Injector
45 Sample receiving volume
50 Detector
60 Fractionator
70 Control unit
100 Process fluid space, sampler
110 Needle
120 Position
121, 122 Further positions
128 Drive
130 Process fluid plate
131 Process fluid container
140 Needle seat
150 Process fluid holder
178 Robot arm
190 Process fluid handling device

1. A method for operating an analysis device for carrying out an analysis method, the method comprising:
providing the analysis device, wherein the analysis device comprises a process fluid handling device configured to handle a plurality of process fluids, and a plurality of defined positions configured to position the process fluids;
selecting a defined position from the plurality of defined positions as a selected position; and
mechanically providing the selected position to a user and/or the process fluid handling device,
wherein the selecting of the selected position is based on the content of the process fluids positioned at the defined positions and/or a user behavior with respect to the process fluids positioned at the defined positions.

2. The method according to claim 1, wherein the user behavior is based on at least one of the following:
past events with respect to the process fluids positioned at the defined positions;
current expectations with respect to the process fluids positioned at the defined positions;
future expectations with respect to the process fluids positioned at the defined positions.

3. The method according to claim 1, wherein the mechanically providing of the selected position comprises at least one of the following: a turning; a pushing; a pivoting; a conveying; a driving; a use of a robot arm.

4. A method for operating an analysis device for carrying out an analysis method, the method comprising:
analysis device, wherein the analysis device comprises a process fluid handling device configured to handle a plurality of process fluids, and a plurality of defined positions configured to position the process fluids; and
automatically selecting a defined position from the plurality of defined positions as a selected position, which is associated with at least one of the plurality of process fluids, as a starting position,
wherein the analysis device is configured as a high-performance liquid chromatography device.

5. The method according to claim 1, comprising positioning one or more process fluid holders of the analysis device at one or more of the defined positions, respectively, wherein each of the one or more process fluid holders comprises one or more process fluid locations for one or more of the process fluids.

6. The method according to claim 5, comprising at least one of the following features:
wherein at least one of the process fluid holders comprises at least one of the following: a tray; a well plate; a process fluid bottle holder; a microtiter plate; a process fluid rack; a vial rack;
wherein the process fluids are provided separately or in one or more process fluid containers.

7. The method according to claim 1, wherein the selecting of the selected position comprises at least one of:
selecting a free position from the plurality of defined positions;
selecting a position from the plurality of defined positions at which a process fluid holder of the analysis device is positioned and comprises free process fluid locations.

8. The method according to claim 1, wherein the selecting of the selected position is based on a circumstance that at least one process fluid of the plurality of process fluids is to be removed.

9. The method according to claim 8, comprising at least one of the following features:
wherein the at least one process fluid is to be removed because the at least one process fluid has already been measured;
wherein the analysis device comprises a process fluid holder that comprises one or more process fluid locations for one or more of the process fluids, including the at least one process fluid, and the process fluid holder is to be removed because the at least one process fluid has already been measured;
wherein the at least one process fluid is to be removed because it has expired and/or is degraded;
wherein the analysis device comprises a process fluid holder that comprises one or more process fluid locations for one or more of the process fluids, including the at least one process fluid, and the process fluid holder is to be removed because the at least one process fluid has expired and/or is degraded;
wherein the at least one process fluid is to be removed because it is no longer trustworthy;
wherein the analysis device comprises a process fluid holder that comprises one or more process fluid locations for one or more of the process fluids, including the at least one process fluid, and the process fluid holder is to be removed because the at least one process fluid is no longer trustworthy.

10. The method according to claim 1, wherein the selecting of the selected position is based on one or more process fluids of the plurality of process fluids to be measured having the highest priority or the lowest priority for performing an analysis.

11. The method according to claim 1, comprising at least one of the following features:
wherein the selecting of the selected position is based on a reference standard being introduced or removed;
wherein the selecting of the selected position is based on a reference standard being introduced or removed because the reference standard has expired and/or is degraded.

12. The method according to claim 1, comprising at least one of the following features:
wherein the selecting of the selected position is based on which position or positions have been used in the past;
wherein the analysis device comprises a plurality of process fluid holders, each process fluid holder comprising process fluid locations for one or more process fluids of the plurality of process fluids, and the selecting of the selected position is based on which process fluid holder or process fluid holders have been used in the past;
wherein the selecting of the selected position is based on a circumstance that at least one process fluid of the plurality of process fluids has been introduced into a control system of the analysis device but has not yet been measured;
wherein the selecting of the selected position is based on an external control system providing a specification;
wherein the selecting of the selected position is based on an external control system providing a specification by meta data.

13. The method according to claim 1, wherein:
the selected position is arranged closer to an opening region of a process fluid space of the analysis device than the other positions of the plurality of defined positions; and
the opening region is configured to introduce and/or discharge at least one of the plurality of process fluids, and/or to place and/or remove a process fluid holder comprising process fluid locations for one or more process fluids of the plurality of process fluids, with respect to the process fluid space.

14. The method according to claim 1, wherein the selecting of the selected position is based on at least one of the following:
an expectation position and/or an experience position;
an expectation margin for a particular position;
performing a particular measurement;
modeling;
simulating;
using an artificial intelligence algorithm.

15. A control device comprising at least a processor and a memory, wherein the control device is configured to control or perform the steps of the method of claim 1.

16. An analysis device for carrying out an analysis method, the analysis device comprising:
the control device of claim 15;
the plurality of defined positions;
a fluidic separation path configured to direct one or more process fluids of the plurality of process fluids to a sample separation unit configured to separate the one or more process fluids; and
a sample injector configured to introduce the one or more process fluids into the fluidic separation path.

17. The analysis device according to claim 16, comprising a process fluid space, wherein the process fluid space comprises at least one of the following: a process fluid plate; a process fluid elevator; a process fluid drawer; a conveyor belt.

18. The analysis device according to claim 17, wherein the process fluid space comprises the process fluid plate, the process fluid plate is configured to rotate in a plane, and the mechanically providing of the selected position comprises rotating the process fluid plate.

19. The analysis device according to claim 17, wherein:
the process fluid space comprises an opening region configured to introduce and/or discharge at least one of the plurality of process fluids, and/or to place and/or remove a process fluid holder comprising process fluid locations for one or more process fluids of the plurality of process fluids;
the selected position is arranged closer to the opening region than the other positions of the plurality of defined positions.

20. The analysis device according to claim 16, comprising at least one of the following features:
the analysis device comprises the sample separation unit;
the analysis device comprises the sample separation unit, and the sample separation unit is configured as a chromatographic separation device;
the analysis device comprises the sample separation unit, and the sample separation unit is configured as a chromatographic separation column;
the analysis device comprises a fluid drive configured to drive a mobile phase, and the one or more process fluids introduced by the injector into the fluidic separation path and thereby injected into the mobile phase, along the fluidic separation path to the sample separation unit;
the analysis device comprises a fluid drive configured to drive a mobile phase, and the one or more process fluids introduced by the injector into the fluidic separation path and thereby injected into the mobile phase, along the fluidic separation path to the sample separation unit, wherein the fluid drive is configured to drive the mobile phase and the one or more process fluids at a pressure selected from the group consisting of: a pressure of at least 500 bar; a pressure of at least 1000 bar; a pressure of at least 1200 bar; a pressure of at least 1500 bar; and a pressure of at least 2000 bar;
the analysis device is configured for analyzing at least one physical, chemical and/or biological parameter of the fluidic sample;
the analysis device is configured as a chromatography device;
the analysis device is configured as a microfluidic device;
the analysis device is configured as a nanofluidic device;
the analysis device comprises a detector configured to detect fractions of the one or more process fluids separated by the sample separation unit;
the analysis device comprises a fractionator configured to collect fractions of one or more of the one or more process fluids separated by the sample separation unit.
